(19) United States
(12) Patent Application Publication
(10) Pub. No.: US 2007/0178018 A1
(43) Pub. Date: Aug. 2, 2007

(54) Disposable container for centrifuging and treating a fluid biological material

(75) Inventor: Michele Virno, Roma (IT)

Correspondence Address: OBLON, SPIVAK, MCCLELLAND, MAIER & NEUSTADT, P.C., 1940 DUKE STREET, ALEXANDRIA, VA, 22314, US

(73) Assignee: AZIENDE CHIM. RIUN. ANG. FRANC. A.C.R.A.F. S.P.A., Roma (IT)

(21) Appl. No.: 10/575,180

(22) PCT Filed: Oct. 6, 2004
(86) PCT No.: PCT/EP04/11349

§ 371 Date: Dec. 12, 2006

(30) Foreign Application Priority Data
Oct. 10, 2003 (IT) RM2003A000467

(51) Int. Cl. B01L 3/00

(52) U.S. Cl. 422/102; 435/283.1

(57) ABSTRACT

A disposable container for centrifuging and treating a fluid biological material. The container includes an open top end and a closed bottom end, the top end including a lid having: a) a first opening passed through by a first cannula that can be connected operationally to the external environment to control entry and exit of air in conjunction with the transfer of a fluid biological material into or from the container; b) a second opening passed through by a second cannula that can be accessed by a hollow needle to transfer a fluid biological material into or from the container through the hollow needle; and c) a third opening passed through by a third cannula operationally connected to an attachment able to receive and accommodate one end of a syringe to transfer a fluid biological material into or from the container through the third cannula.

The present invention relates to a disposable container for centrifuging and treating a fluid biological material.

More particularly, the present invention relates to a sterile disposable container for centrifuging and treating blood.

Recently various techniques for obtaining autologous preparations useful in various therapeutic practices have become widespread, said techniques generally having the drawback that they involve very complex operations in sterile environments which require a lot of time, particularly expert operators and particularly well-equipped laboratories.

An example of said techniques is described in the PCT application WO 01/043787. This method involves the preparation of an autologous platelet gel for accelerating the healing of wounds and comprises the following steps:
collecting 40-50 ml of venous blood from the patient using a first sterile syringe;
transferring said blood from said first syringe to a first sterile test tube;
centrifuging said first test tube at 180 g for 20 minutes, thus obtaining two phases: a dark bottom phase formed by red and white cells and a light top phase formed by platelet-rich plasma;
collecting the light top phase using a second sterile syringe;
transferring said light top phase into a second sterile test tube;
centrifuging said second test tube at 580 g for 20 minutes, thus obtaining a platelet sediment and a supernatant liquid formed by platelet-poor plasma;
collecting said supernatant liquid using a third sterile syringe;
suspending said pellets in a portion of said supernatant liquid sufficient to obtain about 6 ml of platelet concentrate;
collecting said platelet concentrate using a fourth sterile syringe and transferring thereof into a sterile petri dish containing an aqueous solution of a calcium salt and batroxobin;
light shaking the dish for about 30 seconds;
collecting the platelet gel thus formed.

It is an object of the present invention to provide a disposable container which enables the abovementioned drawbacks to be overcome.

In particular, the present invention proposes providing a disposable container which allows operation under sterile conditions in any environment devoid of sterile hoods and which may be obtained by assembling already known constructional elements in a simple and low-cost manner.

The above object is achieved by means of a disposable container for centrifuging and treating a fluid biological material, said container being provided with an open top end and a closed bottom end, characterized in that said top end is provided with a lid having:
a) a first opening passed through by a first cannula which can be connected operationally to the external environment in order to control the entry and exit of air in conjunction with the transfer of a fluid biological material into or from said container;
b) a second opening passed through by a second cannula which can be accessed by a hollow needle in order to transfer a fluid biological material into or from said container through said hollow needle;
c) a third opening passed through by a third cannula operationally connected to an attachment able to receive and accommodate one end of a syringe in order to transfer a fluid biological material into or from said container through said third cannula; and
d) the top end of said first cannula is provided with a removable stopper for performing said control of entry and exit of air in conjunction with the transfer of a fluid biological material into or from said container.

Preferably, said top end and said stopper are both threaded so as to allow screwing or unscrewing of said stopper into/from said top end of said first cannula.

In another embodiment the top end of said first cannula is shaped so as to receive and accommodate one end of a syringe in order to transfer a fluid biological material into or from said container through said first cannula.

In yet another embodiment said first cannula is provided with a tap for performing said control of exit and entry of air in conjunction with the transfer of a fluid biological material into or from said container.

In a further embodiment said control of exit and entry of air in conjunction with the transfer of a fluid biological material into or from said container is obtained by means of suitable valve means.

In a more greatly preferred embodiment, said first cannula is operationally connected to means, such as filtering means for example, which ensure the sterility of the air entering into said container.

Advantageously, said second cannula can be accessed by said hollow needle through a pierceable membrane. Preferably, said pierceable membrane consists of an elastomeric polymer material.

In a preferred embodiment, said hollow needle is provided with a connector able to receive and accommodate one end of a syringe. Even more preferably said end of said syringe is provided with an adaptor also provided with a pierceable membrane of elastomeric polymer material.

Typically, said connector is provided centrally with a rigid straight duct which is preferably metallic and covered with a flexible and pierceable tubular sheath, preferably also consisting of an elastomeric polymer material.

During use, when said syringe provided with said adaptor is inserted into said connector, said rigid straight duct will pierce both the membrane of the adaptor and its tubular sheath, thus forming a fluid connection between the syringe and the hollow needle.

Typical examples of said adaptor and said connector are those used in the devices Monovette™ manufactured by the company Sarstedt AG & Co in Nümbrecht (Germany).

In one embodiment the attachment connected operationally to said third cannula has the same constructional features as the connector described further above in connection with said hollow needle.

Said first, second and third cannula may be provided with any device formed so as to allow a syringe to transfer, under sterile conditions, a fluid biological material into or from said container.

Advantageously, the devices with which said second and third cannula are provided may be formed in a manner identical to or different from each other.

Preferably, the length of said hollow needle is the same as or less than the height of said container.

In a preferred embodiment the length of said third cannula is at least equal to the height of said container.

Typically, the shape of the container according to the present invention is substantially cylindrical.

Advantageously, the shape of said bottom end of said container is substantially tapered and is, for example, substantially conical, frustoconical or hemispherical.

In a preferred embodiment, the disposable container according to the present invention is provided with a base which allows it to remain in an erect position without any need for a support such as, for example, a test-tube holder. Advantageously, said base is formed by an extension of the substantially circular wall of the said container which extends around said bottom end.

Typically, said lid of the container according to the present invention is removable. Even more preferably, it may be screwed onto the top end of container according to the present invention.

Advantageously, the container according to the present invention is graduated.

The present invention will now be described more fully with the aid of the description which follows and the accompanying figures which are provided solely by way of example and not intended to be limiting in any way and in which:

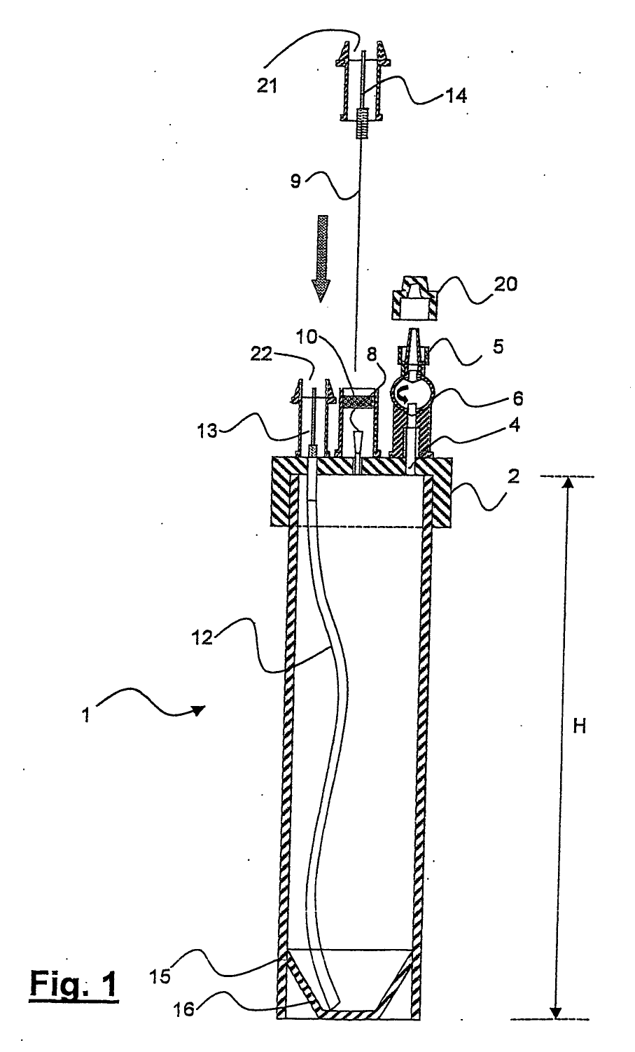

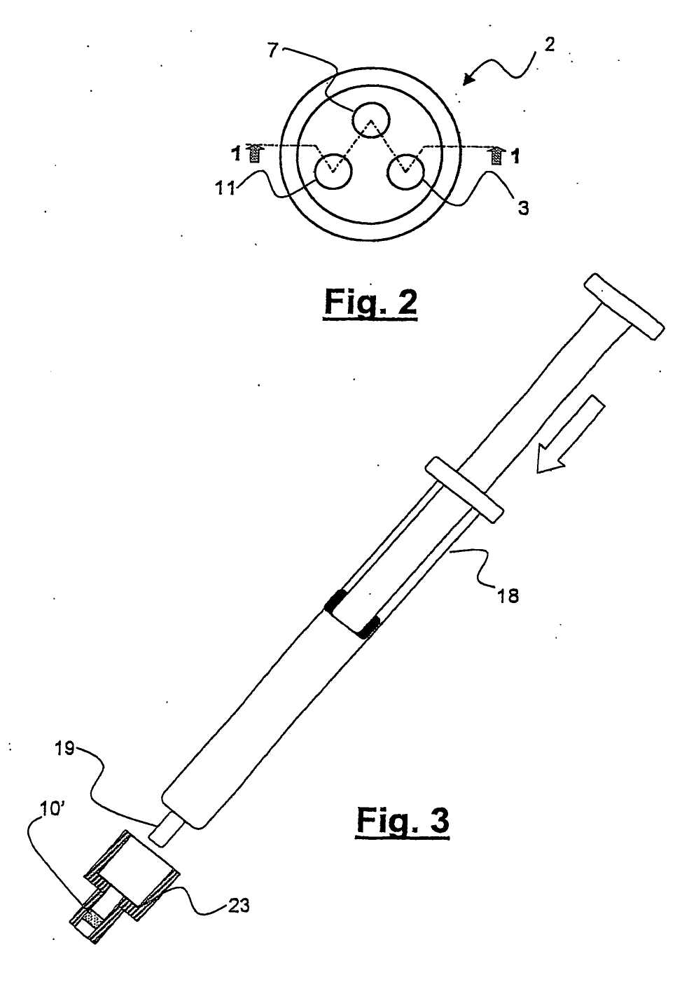

FIG. 1 shows a longitudinal section through a first embodiment of the disposable container according to the present invention, along the line indicated by 1-1 in FIG. 2;

FIG. 2 shows a view, from the bottom, of the lid of the container shown in FIG. 1;

FIG. 3 shows a syringe which may be used in accordance with the present invention;

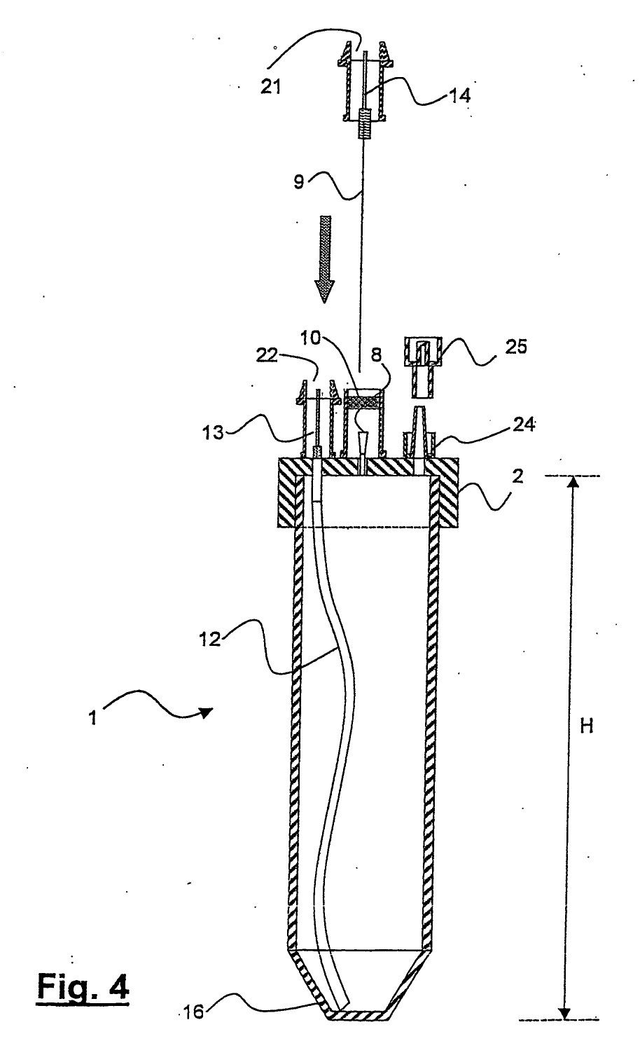

FIG. 4 shows a variant of the container according to FIG. 1, in which the identical constructional elements have been indicated by the same reference numbers.

As shown in FIGS. 1 and 2, in a first embodiment thereof, the container (1) of the present invention is cylindrical and graduated. Moreover, it is provided with a removable lid (2) through which three holes (3, 7, 11) pass.

The first hole (3) houses a first cannula (4) which is operationally connected to a seat (5) able to receive and accommodate one end (19) of a syringe (18) and/or an adaptor (23) fitted onto one end (19) of a syringe (18). A tap (6) is arranged between said seat (5) and said first cannula (4). Moreover, the seat (5) is provided with a removable lid (20).

The second hole (7) houses a second cannula (8) which is separated from the outside by a pierceable membrane (10). A hollow needle (9) is able to pierce said membrane (10) and penetrate into the container (1) through said cannula (8). Moreover, the top end of said hollow needle (9) is provided with a connector (21) provided centrally with a rigid straight duct (14) covered with a flexible and pierceable tubular sheath of elastomer material (not shown). The hollow needle (9) has a length such it is able to descend as far as the bottom of the container (1) of the present invention. The friction with the pierceable membrane (10) and/or the inner wall of the second cannula (8) enables, however, the needle to be kept in any intermediate position. The usefulness of this feature will be illustrated further below.

The third hole (11) houses a third cannula (12). The top end of the third cannula (12) is provided with an attachment (22) provided centrally with a rigid straight duct (13) covered with a flexible and pierceable tubular sheath of elastomer material (not shown).

In this embodiment the attachment (22) has the same structure as the connector (21).

In turn, the bottom portion of the third cannula (12) extends as far as the bottom of the container (1). The bottom end (16) of the container (1) has a frustoconical shape.

The container (1) is provided with a substantially circular shaped base which is formed by an extension (15) of the circular wall of the container (1) which extends around the bottom end (16) of the said container (1).

FIG. 4 shows a second embodiment of the sterile disposable container (10) of the present invention.

The second embodiment differs from that shown in FIGS. 1 and 2 in that it does not have the extension (15) of the circular wall of the container (1).

Moreover, it is not envisaged that the top end (24) of its first cannula (4) is able to receive and accommodate one end (19) of a syringe (18).

It is also not envisaged arranging a tap (6) between said top end (24) and said first cannula (4).

In this second embodiment, control of entry and exit of air in conjunction with the transfer of a fluid biological material into or from said container (1) is obtained by means of a removable stopper (25) associated with the top end (24) of said first cannula (4). Said top portion (24) and said stopper (25) are both threaded so as to allow screwing and unscrewing of said stopper (25) into/from said top portion (24).

In this second embodiment, the venous blood removed from a patient is transferred into the container (1) through the second cannula (8). For this purpose, the needle of a sterile syringe (18) by means of which the venous blood was removed from a patient is inserted into said second cannula (8) through said pierceable membrane (10).

By way of example, the implementation of the method of PCT application WO 01/043787 using the sterile disposable container (1) of FIGS. 1-2 will now be described.

40-50 ml of venous blood are collected from a patient using a first sterile syringe provided with a needle.

A sterile container (1) is provided and, after removing the needle of said first syringe and the removable lid (20) which protects the seat (5), the end (19) of said first syringe (18) is sealingly inserted into the seat (5). Alternatively, said seat (5) may be shaped so as to sealingly mate with an adaptor (23) fitted onto the end (19) of said first syringe (18). Then the tap (6) is opened and, pressing the plunger of said first syringe downwards, the venous blood is transferred into the container (1) under sterile conditions through said first cannula.

After transferring all the blood from said first syringe into the container (1) under sterile conditions, the tap (6) is closed. The container (1) is placed in a centrifuge (not shown) and it is centrifuged at a prechosen speed and for a prechosen duration so as to obtain two phases: a dark bottom phase consisting of red and white cells and a light top phase consisting of platelet-rich plasma. Advantageously, the centrifuge is operated at 180 g for 20 minutes.

A sterile adaptor (23) is fitted onto the end (19) of a second sterile syringe. The adaptor (23) is provided with a pierceable membrane (10′).

The second syringe (18) provided with an adaptor (23) with the plunger lowered is inserted under pressure into the attachment (22). Owing to said pressure, the sterile, rigid, straight duct (13) of the attachment pierces both the top end of its tubular sheath (not shown) and the membrane (10′) of the sterile adaptor (23), thus providing a sterile fluid connection between the second syringe (18) and the third cannula (12).

Then, said plunger is raised so as to draw off slowly from the bottom of said container (1), through said third cannula (12), said dark bottom phase consisting of red and white cells. When drawing-off has been completed, said second syringe is removed from the attachment (22). During said drawing-off operation said tap (6) may be opened so as to allow the entry, through said first cannula (4), of a volume of air such as to compensate for the volume of said dark phase drawn off through said third cannula (12).

The container (1) is again placed inside a centrifuge (not shown) and is centrifuged at a prechosen speed and for a prechosen duration so as to obtain two phases: a sediment of platelets and a supernatant liquid consisting of platelet-poor plasma. Advantageously, the centrifuge is operated at 580 g for 20 minutes.

A sterile adaptor (23) is then fitted onto the end (19) of a third sterile syringe. The adaptor (23) is provided with a pierceable membrane (10′)

The third syringe (18) provided with an adaptor (23) with the plunger lowered is inserted under pressure into the connector (21) provided with a hollow needle (9). Owing to said pressure, the sterile, rigid, straight duct (14) of the connector (21) pierces both the top end of its tubular sheath (not shown) and the membrane (10′) of the sterile adaptor (23), thus providing a sterile fluid connection between the third syringe (18) and the hollow needle (9).

The hollow needle (9) is inserted into the second cannula (8) through the membrane (10) and is submerged into said supernatant liquid consisting of platelet-poor plasma, thus providing a sterile fluid connection between the third syringe (18) and the supernatant liquid.

Finally, the latter is drawn of from the container (1) through said hollow needle (9), slowly raising the plunger of the third sterile syringe (18). During this operation, the bottom end of the hollow needle (9) is maneuvered and positioned so as to leave on the bottom of the graduated container about 6 ml of a material consisting of the sediment of platelets and a proportion of the supernatant liquid consisting of platelet-poor plasma. Moreover, during said drawing-off operation, said tap (6) may be opened in order to allow the entry, through said cannula (4), of a volume of air such as to compensate for the volume of said supernatant liquid drawn off through said hollow needle (9).

A fourth sterile syringe (18) is envisaged, being provided with its own adaptor (23) and its own hollow needle (9) provided with its own connector (21). The hollow needle (9) of said fourth sterile syringe (18) is inserted into said container (1) through said pierceable membrane (10) and said second cannula (8) so as to inject into the container (1) a known activating solution consisting of an aqueous solution of a suitable enzyme and an organic or inorganic salt of calcium. Typical examples of suitable enzymes are thrombin, batroxobin and fibrin. Typical examples of suitable calcium salts are chloride, gluconate and lactate.

The container (1) is stirred slowly for about 30 seconds.

An autologous platelet gel, of the type described in the PCT application WO 01/043787, to be used to accelerate the healing of wounds, is thus formed.

The autologous platelet gel thus obtained is easily removed from the container (1) after unscrewing and removing the lid (2).

It will be noted that the container (1) offers the advantage of obtaining an autologous platelet gel in the same container (1) into which the venous blood collected from the patient was transferred without the need for any further transfer operations. This offers the great advantage of helping maintain sterile conditions and facilitating the task of the operator.

Even though the present description is described in particular with regard to the preparation of an autologous platelet gel of the type described in the PCT application WO 01/043 787, the person skilled in the art will appreciate that the sterile disposable container according to the present invention is suitable for implementing many other methods which involve various operations of centrifuging and/or treating biological fluids in a sterile environment.

1-19. (canceled)

20. A disposable container for centrifuging and treating a fluid biological material, the container comprising:
an open top end and a closed bottom end, wherein the top end comprises a removable lid including:
a) a first opening passed through by a first cannula that can be connected operationally to the external environment to control entry and exit of air in conjunction with transfer of a fluid biological material into or from the container;
b) a second opening passed through by a second cannula that can be accessed by a hollow needle to transfer a fluid biological material into or from the container through the hollow needle;
c) a third opening passed through by a third cannula operationally connected to an attachment configured to receive and accommodate one end of a syringe to transfer a fluid biological material into or from the container through the third cannula whose length is at least equal to the height of the container; and
d) wherein the top end of the first cannula includes a removable stopper for controlling the entry and exit of air in conjunction with the transfer of a fluid biological material into or from the container.

21. A container according to claim 20, wherein the top end of the first cannula is shaped so as to receive and accommodate one end of a syringe or an adaptor fitted onto the end of the syringe to transfer a fluid biological material into or from the container through the first cannula.

22. A container according to claim 21, further comprising a tap arranged between the top end and the first cannula.

23. A container according to claim 20, wherein the second cannula can be accessed by the hollow needle through a pierceable membrane.

24. A container according to claim 23, wherein the hollow needle includes a connector configured to receive and accommodate one end of a syringe.

25. A container according to claim 24, wherein the end of a syringe includes an adaptor including a pierceable membrane.

26. A container according to claim 24, wherein the connector includes centrally a rigid straight duct covered with a flexible and pierceable sheath.

27. A container according to claim 20, wherein the attachment includes centrally a rigid straight duct covered with a flexible and pierceable sheath.

28. A container according to claim 20, wherein the length of the hollow needle is the same as or less than the height of the container.

29. A container according to claim 20, wherein the length of the third cannula is at least equal to the height of the container.

30. A container according to claim 20, wherein the shape of the container is substantially cylindrical.

31. A container according to claim 20, wherein the shape of the bottom end of the container is substantially tapered.

32. A container according to claim 31, wherein the shape of the bottom end of the container is substantially conical.

33. A container according to claim 31, wherein the shape of the bottom end of the container is substantially frustoconical.

34. A container according to claim 31, wherein the shape of the bottom end of the container is substantially hemispherical.

35. A container according to claim 31, wherein the container further comprises a substantially circular base formed by an extension of the circular wall of the container that extends around the bottom end of the container.

36. A container according to claim 20, wherein the lid is configured to be screwed onto the top end of the container.

37. A container according to claim 20, wherein the container is graduated.
